(19) United States
(12) Patent Application Publication
(10) Pub. No.: US 2023/0057002 A1
(43) Pub. Date: Feb. 23, 2023

(54) METHOD AND DEVICE FOR ACCOUNTING FOR VIRTUAL ASSET

(71) Applicant: WOORI FUND SERVICES, Seoul (KR)

(72) Inventors: Young-Bae KO, Seoul (KR); Joon-Hyung PARK, Seoul (KR); Kil-Young KIM, Seoul (KR); Ki-Su EOM, Seoul (KR)

(21) Appl. No.: 17/889,646

(22) Filed: Aug. 17, 2022

(30) Foreign Application Priority Data
Aug. 17, 2021 (KR) 10-2021-0108281
May 17, 2022 (KR) 10-2022-0060022

(51) Int. Cl. G06Q 40/00; G06Q 20/38

(52) U.S. Cl. CPC G06Q 40/12; G06Q 20/389

(57) ABSTRACT

Disclosed are a method and a device for accounting for virtual assets. The device includes a receiver for receiving log data including a plurality of transaction recording data from a virtual asset exchange server; a transaction analyzer for extracting transaction recording data included in the log data, and allocating an account item and a transaction classification item to the transaction recording data, with reference to a predetermined transaction analysis table; and an accounting unit for journalizing the transaction recording data based on the account item and the transaction classification item to create journalized data.

### CROSS-REFERENCE TO RELATED APPLICATION

This application claims priority from Korean Patent Application No. 10-2021-0108281, filed on Aug. 17, 2021, and Korean Patent Application No. 10-2022-0060022, filed on May 17, 2022 in the Korean Intellectual Property Office, and all the benefits accruing therefrom under 35 U.S.C. 119, the contents of which are herein incorporated by reference.

### BACKGROUND

### Field

The present disclosure relates to a method and a device for accounting for virtual asset.

### Description of Related Art

Accounting includes measuring all factors related to a company’s economic activities in monetary units and recording the measurements based on numerical values, and producing information that is provided for subjects who need the measurements to easily make economic decision-making. In particular, importance of accurate and transparent accounting is increasing in order to provide information for investors who invest in a company or pay company taxes.

For company accounting, transactions with other economic entities are recorded according to certain rules, and this transaction recording act is called journalizing. In the journalizing process, an account item along with a transaction amount are allocated to each transaction, and each transaction is recorded in debit and credit based on the allocation.

Recently, virtual assets (e.g., cryptocurrencies), which are new types of digital assets rather than general types of assets, are being actively traded. Virtual assets are traded in various transaction types (e.g., airdrop, token swap, hard-fork, staking, etc.) in addition to general transaction types (e.g., buy or sell). Due to these new transaction types, accounting for virtual asset transaction detail becomes complicated or impossible in the journalizing process.

### SUMMARY

A purpose of the present disclosure is to provide a method and a device for accounting for virtual assets that enable rapid and accurate accounting for virtual asset transaction detail.

Purposes of the present disclosure are not limited to the above-mentioned purpose. Other purposes and advantages of the present disclosure that are not mentioned may be understood based on following descriptions, and may be more clearly understood based on embodiments of the present disclosure. Further, it will be easily understood that the purposes and advantages of the present disclosure may be realized using means shown in the claims and combinations thereof.

A first aspect of the present disclosure provides a device for accounting for virtual assets, the device comprising: a receiver for receiving log data including a plurality of transaction recording data from a virtual asset exchange server; a transaction analyzer for extracting transaction recording data included in the log data, and allocating an account item and a transaction classification item to the transaction recording data, with reference to a predetermined transaction analysis table; and an accounting unit for journalizing the transaction recording data based on the account item and the transaction classification item to create journalized data, wherein the transaction analyzer is configured to: when the account item or the transaction classification item corresponding to transaction detail recorded in the transaction recording data is absent in the transaction analysis table, set the account item of the transaction recording data as an unknown variable transaction item; and analyze the transaction detail of the transaction recording data and set the transaction classification item of the transaction recording data as a predetermined alternative transaction item based on the analysis result.

In one implementation of the device, the transaction analyzer is further configured to: upon determining, based on a result of analyzing the transaction detail of the transaction recording data, that a quantity of the virtual assets has increased, set the transaction classification item of the transaction recording data as an alternative deposit item; upon determining, based on the result of analyzing the transaction detail of the transaction recording data, that the quantity of the virtual assets has decreased, set the transaction classification item of the transaction recording data as an alternative withdrawal item; upon determining, based on the result of analyzing the transaction detail of the transaction recording data, that a cost for the virtual assets has been spent, set the transaction classification item of the transaction recording data as an alternative buy item; and upon determining, based on the result of analyzing the transaction detail of the transaction recording data, that a profit from the virtual assets has increased, set the transaction classification item of the transaction recording data as an alternative sell item.

In one implementation of the device, the accounting unit is configured to: when an account item of any transaction recording data is updated, update the journalized data based on the transaction recording data having the updated account item.

In one implementation of the device, the transaction analyzer or the accounting unit prioritize the transaction recording data about the virtual assets over transaction recording data for general assets.

In one implementation of the device, the transaction analyzer is further configured to: when the account item or the transaction classification item corresponding to the transaction detail recorded in the transaction recording data is absent in the transaction analysis table, compare a transaction code included in the transaction recording data a transaction code included in another transaction recording data; and determine the account item or the transaction classification item of the transaction recording data based on the comparison result.

A second aspect of the present disclosure provides a method for accounting for virtual assets, the method comprising: receiving, by a receiver, log data including a plurality of transaction recording data from a virtual asset exchange server; extracting, by a transaction analyzer, transaction recording data included in the log data, and allocating, by the transaction analyzer, an account item and a transaction classification item to the transaction recording data, with reference to a predetermined transaction analysis table; and journalizing, by an accounting unit, the transaction recording data based on the account item and the transaction classification item to create journalized data, wherein the allocating of the account item and the transaction classification item to the transaction recording data includes: when the account item or the transaction classification item corresponding to transaction detail recorded in the transaction recording data is absent in the transaction analysis table, setting the account item of the transaction recording data as an unknown variable transaction item; and analyzing the transaction detail of the transaction recording data and setting the transaction classification item of the transaction recording data as a predetermined alternative transaction item based on the analysis result.

In one implementation of the method, the allocating of the account item and the transaction classification item to the transaction recording data includes: upon determining, based on a result of analyzing the transaction detail of the transaction recording data, that a quantity of the virtual assets has increased, setting the transaction classification item of the transaction recording data as an alternative deposit item; upon determining, based on the result of analyzing the transaction detail of the transaction recording data, that the quantity of the virtual assets has decreased, setting the transaction classification item of the transaction recording data as an alternative withdrawal item; upon determining, based on the result of analyzing the transaction detail of the transaction recording data, that a cost for the virtual assets has been spent, setting the transaction classification item of the transaction recording data as an alternative buy item; and upon determining, based on the result of analyzing the transaction detail of the transaction recording data, that a profit from the virtual assets has increased, setting the transaction classification item of the transaction recording data as an alternative sell item.

In one implementation of the method, the method further comprises, when an account item of any transaction recording data is updated, updating the journalized data based on the transaction recording data having the updated account item.

In one implementation of the method, the allocating of the account item and the transaction classification item to the transaction recording data or the journalizing of the transaction recording data includes prioritizing the transaction recording data about the virtual assets over transaction recording data for general assets.

In one implementation of the method, the allocating of the account item and the transaction classification item to the transaction recording data includes: when the account item or the transaction classification item corresponding to the transaction detail recorded in the transaction recording data is absent in the transaction analysis table, comparing a transaction code included in the transaction recording data a transaction code included in another transaction recording data; and determining the account item or the transaction classification item of the transaction recording data based on the comparison result.

The device and the method according to the embodiments may quickly and accurately account for virtual asset transaction detail. Accordingly, accurate analysis of value change of the virtual assets treated as intangible assets under the tax law may be executed. Further, identification and comparison of balances and actual holdings of the virtual assets may be automated.

Further, according to the embodiments, accounting for virtual assets is automated, so that financial stability of the virtual assets with high volatility may be improved, and value evaluation and analysis of the virtual assets may be facilitated.

Further, according to the embodiments, efficiency of company management may be increased because rapid creation and inquiry of secondary data based on the accounting data about the virtual assets may be achieved.

Effects of the present disclosure are not limited to the above-mentioned effects, and other effects as not mentioned will be clearly understood by those skilled in the art from following descriptions.

### BRIEF DESCRIPTION OF DRAWINGS

FIG. 1 is a configuration diagram of a device for accounting for virtual assets according to an embodiment.

FIGS. 2 to 5 show a transaction analysis table referenced when the device accounts for virtual assets in accordance with one embodiment.

FIG. 6 is a flowchart of a virtual asset accounting method according to one embodiment.

### DETAILED DESCRIPTIONS

Advantages and features of the present disclosure, and a method of achieving the advantages and features will become apparent with reference to embodiments described later in detail together with the accompanying drawings. However, the present disclosure is not limited to embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof.

The features of the various embodiments of the present disclosure may be partially or entirely combined with each other, and may be technically associated with each other or operate with each other. The embodiments may be implemented independently of each other and may be implemented together in an association relationship.

In descriptions of temporal relationships, for example, temporal precedent relationships between two events such as “after”, “subsequent to”, “before”, etc., another event may occur therebetween unless “directly after”, “directly subsequent” or “directly before” is not indicated.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

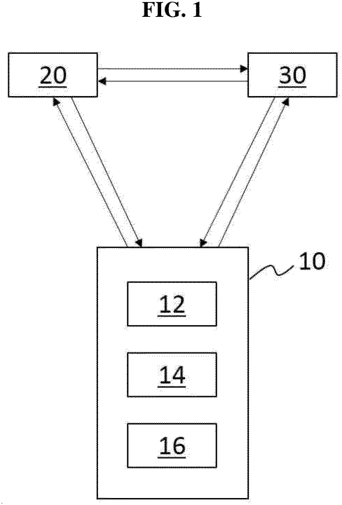

FIG. 1 is a configuration diagram of a device for accounting for virtual assets according to an embodiment.

As shown in FIG. 1, a device 10 for accounting for the virtual asset according to an embodiment may communicate with a virtual asset exchange server 20 or a company server 30.

The virtual asset exchange server 20 is operated by a virtual asset exchange operator. The virtual asset exchange server 20 may process transaction of virtual assets according to a transaction request signal transmitted from the company server 30. For example, the virtual asset exchange server 20 may transfer funds for virtual asset buy of a company operating the company server 30 to an account of a virtual asset seller according to a virtual asset buy transaction request transmitted from the company server 30, and may transfer the virtual asset of the virtual asset seller to an account (e.g., an electronic wallet) of the company operating the company server 30.

Whenever virtual asset transaction according to a request from the company operating the company server 30 occurs, the virtual asset exchange server 20 may store therein information related to the corresponding virtual asset transaction as transaction recording data. In one embodiment, the virtual asset exchange server 20 may create log data including multiple transaction recording data.

The company server 30 is operated by the company. An operator of the company server 30 may access the virtual asset exchange server 20 through the company server 30 and may perform virtual asset transaction using the server 20.

The device 10 for accounting for virtual assets according to one embodiment may include a receiver 12, a transaction analyzer 14, and an accounting unit 16.

The receiver 12 may receive the log data including a plurality of transaction recording data from the virtual asset exchange server 20. In one embodiment, the transaction recording data may include transaction date information, asset type information (type of traded asset), transaction type information (type of transaction such as buy, sales or loan, etc.), a transaction code (unique identification information for identifying each transaction), electronic wallet address information, transaction quantity information (quantity of traded assets), and cost information (cost required for asset transaction, for example, transaction fee, interest, etc.).

[Table 1] and [Table 2] show illustrative transaction recording data included in the log data.

Table 1

| | |
|---|---|
| Transaction Date | 20210307 |
| Asset Type | ATOM |
| Transaction Type | OT |
| Transaction Code | 63087ADAE9720AD7147E954FA7E11DDBC0D761140 |
| Electronic Wallet Address | cosmos1hjyde2kfgtl78twvhs53u5j2gcsxrt649nn8j5 |
| Transaction Amount | 93.995 |
| Cost | 0.005 |

The transaction recording data in [Table 1] is the transaction recording data that occurs on Mar. 7, 2021. This data indicates that the company operating the company server 30 sells (OT) 93.995 cryptocurrencies with a name “ATOM”, and the cost incurring at this transaction is 0.005% of a transaction payment.

Table 2

| | |
|---|---|
| Transaction Date | 20210307 |
| Asset Type | BTC |
| Transaction | BR |
| Transaction Code | 5f4fd0de075864380463d0e16c89155e0f3120523d02c |
| Electronic Wallet Address | 19SK9LWSXLdmwPxvjPgvUrdaPhaPS6LaNu |
| Transaction Amount | 0.001 |
| Cost | 0 |

The transaction recording data in [Table 2] is transaction recording data that occurs on Mar. 7, 2021. This data indicates that the company operating the company server 30 borrows (BR) 0.001 cryptocurrency with a name of “BTC” and the cost incurring at this transaction is zero.

The transaction analyzer 14 may extract each of the transaction recording data included in the log data received through the receiver 12. For example, the transaction analyzer 14 may extract the transaction recording data as listed in [Table 1] or [Table 2] from the log data.

The transaction analyzer 14 may allocate an account item and a transaction classification item to the extracted transaction recording data with reference to a predetermined transaction analysis table.

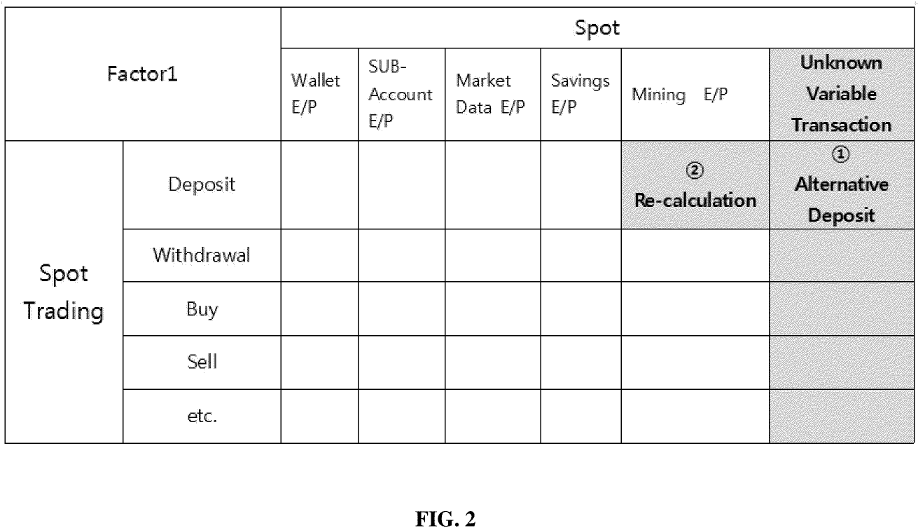

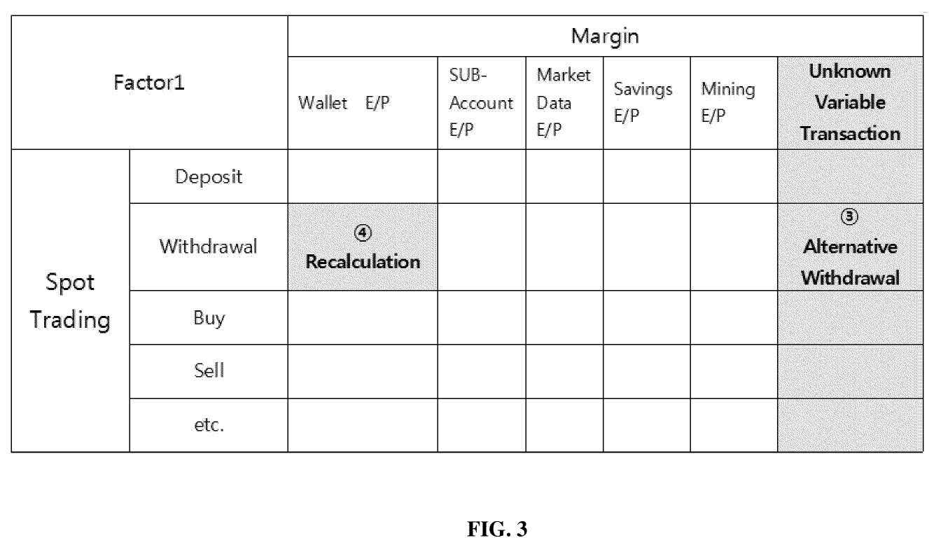

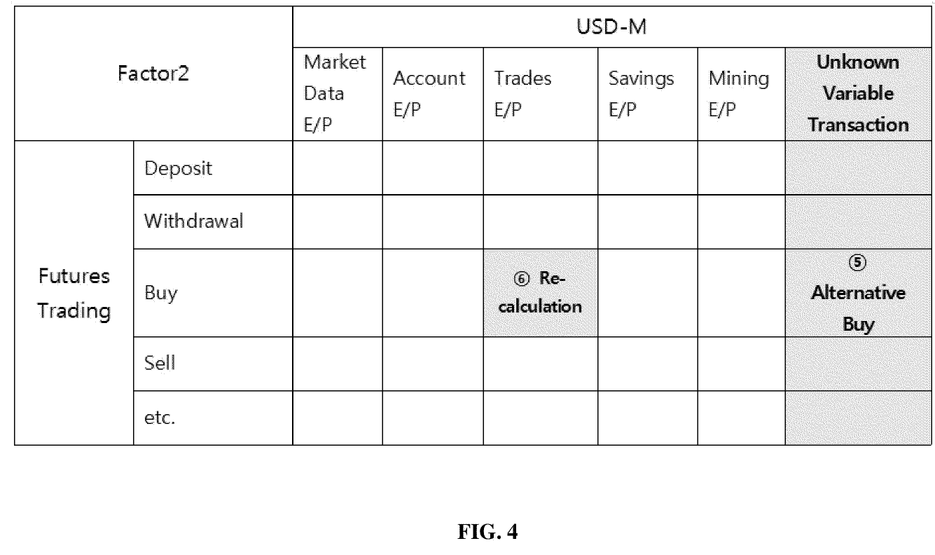

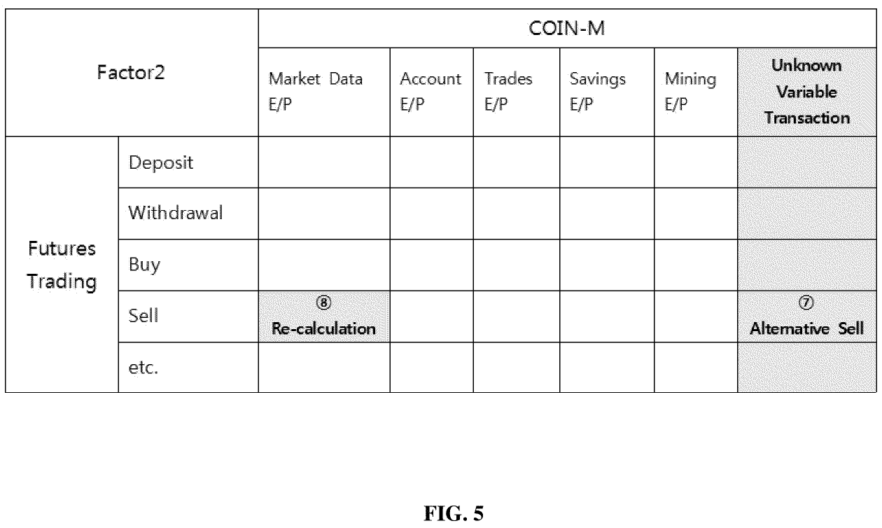

FIGS. 2 to 5 show a transaction analysis table referenced when the device accounts for virtual assets in accordance with one embodiment.

FIGS. 2 to 5 shows an illustrative transaction analysis table to that the transaction analyzer 14 refers to determine the account item and the transaction classification item corresponding to each transaction recording data. In the embodiment of FIGS. 2 to 5, virtual asset transaction is largely classified into real-asset transaction and futures transaction (high level classification). Further, the real-asset transaction may be classified into spot transaction and margin transaction, while the futures transaction may be classified into USD-M transaction and COIN-M transaction (middle level classification).

Further, each of the spot transaction and the margin transaction may be classified into inter-wallet transaction (Wallet E/P), sub-account transaction (SUB-Account E/P), market data transaction (Market Data E/P), and saving transaction (Saving E/P), mining transaction (E/P), and unknown variable transaction (low level classification).

Further, each of the USD-M transaction and the COIN-M transaction may be classified into inter-wallet transaction (Wallet E/P), sub-account transaction (SUB-Account E/P), market data transaction (Market Data E/P), and saving transaction (Saving E/P), mining transaction (E/P), and unknown variable transaction (low level classification).

The classification criteria and classification items as shown in FIGS. 2 to 5 are only examples. According to an embodiment, a transaction analysis table based on other classification criteria and classification items may be created and referenced.

The transaction analyzer 14 may assign an account item and a transaction classification item to the extracted transaction recording data with reference to the transaction analysis table shown in FIGS. 2 to 5.

For example, when the transaction recording data as shown in [Table 1] are extracted, the transaction analyzer 14 may identify that the corresponding transaction is real-asset transaction/spot transaction/inter-wallet transaction in which the company sells 93.995 cryptocurrencies with the name “ATOM” based on the information included in the transaction recording data. Accordingly, the transaction analyzer 14 may assign the account item of the transaction recording data of [Table 1] to “real-asset transaction/spot transaction/inter-wallet transaction” and the transaction classification item to “sell”.

In one embodiment, when it is determined that an account item or a transaction classification item corresponding to the transaction detail recorded in the transaction recording data does not exist in the transaction analysis table, the transaction analyzer 14 may set the account item of the transaction recording data as an unknown variable transaction item.

For example, the transaction recording data in [Table 2] is the transaction recording data that occurs on Mar. 7, 2021, and means that the company operating the company server 30 borrows (BT) 0.001 cryptocurrency with the name of “BTC”. However, the transaction analyzer 14 could not find an account item corresponding to a combination of the information included in the transaction recording data of [Table 2] in the transaction analysis table, or some (for example, asset type, transaction type, transaction code, etc.) of the information included in the transaction recording data of [Table 2] may be omitted. For example, when some of the information (e.g., asset type, transaction type, transaction code, etc.) included in the transaction recording data in [Table 2] is new information or code that did not previously exist, the transaction analyzer 14 may not be able to find the account item corresponding to the combination of the information included in the transaction recording data in [Table 2] in the transaction analysis table.

For this reason, when the account item corresponding to the transaction recording data of [Table 2] is not identified, the transaction analyzer 14 may set the account item of the transaction recording data of [Table 2] to “unknown variable transaction”.

Further, when the transaction analyzer 14 determines that in the transaction analysis table is free of an account item or a transaction classification item corresponding to the transaction detail recorded in the transaction recording data, the transaction analyzer 14 may analyze the transaction detail of the transaction recording data, and may set the transaction classification item of the transaction recording data as a predetermined alternative transaction item based on the analysis result.

In one embodiment, when it is determined that an quantity of virtual assets has increased based on a result of analyzing the transaction detail of the transaction recording data, the transaction analyzer 14 may set the transaction classification item of the transaction recording data as an alternative deposit item. Further, when it is determined that the quantity of virtual assets has decreased based on a result of analyzing the transaction detail of the transaction detail, the transaction analyzer 14 may set the transaction classification item of the transaction recording data as an alternative withdrawal item. Further, when it is determined that a cost for the virtual asset transaction has been spent based on a result of analyzing the transaction detail of the transaction recording data, the transaction analyzer 14 may set the transaction classification item of the transaction recording data as an alternative buy item. Further, when it is determined that a profit from the virtual assets has increased based on a result of analyzing the transaction detail of the transaction recording data, the transaction analyzer 14 may set the transaction classification item of the transaction recording data as an alternative sell item.

For example, when it is determined that the account item corresponding to the transaction recording data in [Table 2] does not exist, the transaction analyzer 14 may determine whether the quantity of virtual assets increases or decreases, whether the cost is spent, and whether the profit increases or decreases, based on a result of analyzing the transaction detail of the transaction recording data in [Table 2], and then may set the transaction classification item corresponding to the transaction recording data of [Table 2] as one of “alternative deposit, alternative withdrawal, alternative buy, or alternative sell” based on the determination result. In one example, when it is not clearly determined whether the quantity of virtual assets increases or decreases, whether the cost is spent, and whether the profit increases or decreases, based on a result of analyzing the transaction detail of the transaction recording data in [Table 2], the transaction analyzer 14 may set the transaction classification item corresponding to the transaction recording data of [Table 2] as “other”.

In one embodiment, when an account item or a transaction classification item corresponding to the transaction detail recorded in the transaction recording data is absent in the transaction analysis table, the transaction analyzer 14 may compare the transaction code included in the transaction recording data with a transaction code included in another transaction recording data, and may determine an account item or a transaction classification item of the transaction recording data according to the comparison result.

For example, when it is determined that the account item corresponding to the transaction recording data in [Table 2] does not exist in the transaction analysis table, the transaction analyzer 14 may compare the transaction code included in the transaction recording data of [Table 2] with a transaction code included in another transaction recording data. When an identity percentage between the transaction code included in the transaction recording data of [Table 2] and the transaction code included in another transaction recording data exceeds a predetermined reference value, the transaction analyzer 14 may set the account item of the transaction recording data of [Table 2] to be the same as an account item of the transaction recording data that is compared therewith.

The accounting unit 16 may journalize the transaction recording data based on the account item and the transaction classification item allocated to the transaction recording data to create journalized data. In one embodiment, the accounting unit 16 may create another accounting data (e.g., financial statements, income statement, transaction detail confirmation, etc.) based on the created journalized data, and may transmit the created accounting data to another device, such as the virtual asset exchange server 20, the company server 30, or any other device.

In one embodiment, when an account item of any transaction recording data is updated, the accounting unit 16 may update the journalized data based on the transaction recording data having the updated account item.

As shown in FIGS. 2 to 5, an account item of each transaction recording data whose the account item is set as “unknown variable transaction” may be updated by the transaction analyzer 14 via a transaction detail analysis process. For example, via the analysis process of the transaction detail of the transaction recording data whose the account item is set as “unknown variable transaction” (①), the account item of the corresponding transaction recording data may be updated into real-asset transaction/spot transaction/mining transaction (②). In the same way, the account items of the transaction recording data whose the account items are respectively set as “unknown variable transactions” (③, ⑤, ⑦) may be updated into new account items (④, ⑥, ⑧) respectively via the transaction detail analysis process.

Depending on embodiments, a classified item itself of the transaction analysis table shown in FIGS. 2 to 5 may be newly created or changed via the transaction detail analysis process. In this case, the transaction analyzer 14 may update an account item of each of transaction recording data whose the account item is set as “unknown variable transaction”, with reference to the updated transaction analysis table.

When the account item of each of the transaction recording data whose the account item is set as “unknown variable transaction” is updated in the above manner, the accounting unit 16 may update the previously created journalized data based on the updated transaction recording data.

According to embodiments, the device 10 for accounting for virtual assets may receive not only transaction recording data about the virtual assets but also transaction recording data about non-virtual assets, that is, general assets. In this case, the device may receive the transaction recording data about non-virtual assets, that is, general assets, together with the transaction recording data about the virtual assets. In this case, the transaction analyzer 14 or the accounting unit 16 may prioritize the transaction recording data about the virtual assets over the transaction recording data about the general assets.

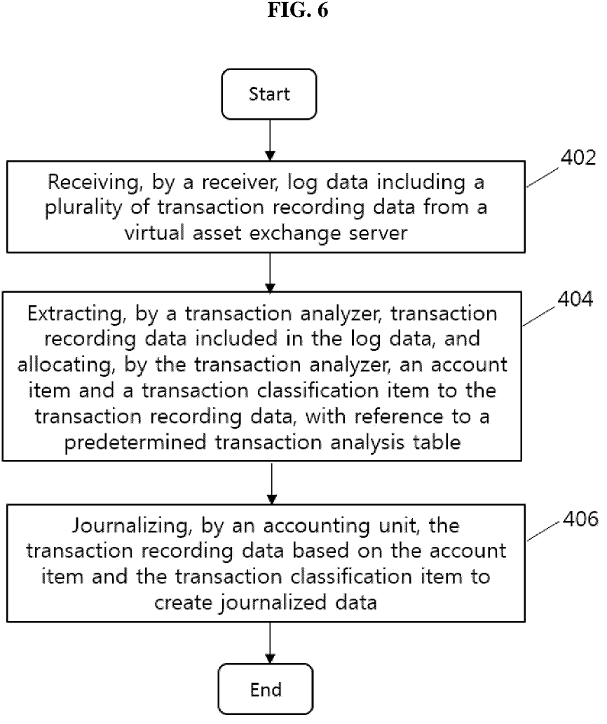

FIG. 6 is a flowchart of a virtual asset accounting method according to one embodiment.

Referring to FIG. 1 and FIG. 6, the receiver 12 receives the log data including a plurality of transaction recording data from the virtual asset exchange server 20 in 402.

The transaction analyzer 14 extracts transaction recording data included in the log data, and allocates an account item and a transaction classification item to the transaction recording data with reference to a predetermined transaction analysis table in 404.

In one embodiment, the allocating of the account item and the transaction classification item to the transaction recording data in 404 may include: when an account item or a transaction classification item corresponding to the transaction detail recorded in the transaction recording data does not exist in the transaction analysis table, the account item of the transaction recording data is set as an unknown variable transaction item; and analyzing the transaction detail of the transaction recording data; and setting the transaction classification item of the transaction recording data as a predetermined alternative transaction item.

In one embodiment, the allocating of the account item and the transaction classification item to the transaction recording data in 404 may include: when it is determined that the quantity of virtual assets has increased based on a result of analyzing the transaction detail of the transaction recording data, setting the transaction classification item of the transaction recording data as an alternative deposit item; when it is determined that the quantity of virtual assets has decreased based on a result of analyzing the transaction detail of the transaction recording data, setting the transaction classification item of the transaction recording data as an alternative withdrawal item; when it is determined that the cost for the virtual asset has been spent based on a result of analyzing the transaction detail of the transaction recording data, setting the transaction classification item of the transaction recording data as an alternative buy item; and when it is determined that the profit from the virtual asset has increased based on a result of analyzing the transaction detail of the transaction recording data, setting the transaction classification item of the transaction recording data as an alternative sell item.

In one embodiment, the allocating of the account item and the transaction classification item to the transaction recording data in 404 may include: when the transaction analysis table is free of the account item or the transaction classification item corresponding to the transaction detail recorded in the transaction recording data, comparing the transaction code included in the transaction recording data with the transaction code included in another transaction recording data, and determining an account item or a transaction classification item of the transaction recording data based on the comparison result.

The accounting unit 16 may journalize the transaction recording data based on the account item and the transaction classification item to create the journalized data in 406. In one embodiment, the accounting unit 16 may create another accounting data (e.g., financial statements, income statement, transaction detail confirmation, etc.) based on the created journalized data, and may transmit the created accounting data to another device, such as the virtual asset exchange server 20, the company server 30, or any other device.

The virtual asset accounting method according to one embodiment may further include: when the account item of any transaction recording data is updated, updating, by the accounting unit 16, the journalized data based on the transaction recording data having the updated account item.

In one embodiment, the transaction analyzer 14 or the accounting unit 16 may prioritize the transaction recording data about the virtual assets over the transaction recording data about the general assets.

The present disclosure has been described above with reference to the illustrated drawings. However, the present disclosure is not limited to the embodiments and drawings disclosed in the present disclosure, and various modifications may be made by those skilled in the art. In addition, even when effects according to configurations of the present disclosure were not explicitly described above while describing the embodiments of the present disclosure, the effects predictable from the configurations should be acknowledged.

What is claimed is:

1. A device for accounting for virtual assets, the device comprising:
a receiver for receiving log data including a plurality of transaction recording data from a virtual asset exchange server;
a transaction analyzer for extracting transaction recording data included in the log data, and allocating an account item and a transaction classification item to the transaction recording data, with reference to a predetermined transaction analysis table; and
an accounting unit for journalizing the transaction recording data based on the account item and the transaction classification item to create journalized data,
wherein the transaction analyzer is configured to:
when the account item or the transaction classification item corresponding to transaction detail recorded in the transaction recording data is absent in the transaction analysis table,
set the account item of the transaction recording data as an unknown variable transaction item; and
analyze the transaction detail of the transaction recording data and set the transaction classification item of the transaction recording data as a predetermined alternative transaction item based on the analysis result.

2. The device of claim 1, wherein the transaction analyzer is further configured to:
upon determining, based on a result of analyzing the transaction detail of the transaction recording data, that a quantity of the virtual assets has increased, set the transaction classification item of the transaction recording data as an alternative deposit item;
upon determining, based on the result of analyzing the transaction detail of the transaction recording data, that the quantity of the virtual assets has decreased, set the transaction classification item of the transaction recording data as an alternative withdrawal item;
upon determining, based on the result of analyzing the transaction detail of the transaction recording data, that a cost for the virtual assets has been spent, set the transaction classification item of the transaction recording data as an alternative buy item; and
upon determining, based on the result of analyzing the transaction detail of the transaction recording data, that a profit from the virtual assets has increased, set the transaction classification item of the transaction recording data as an alternative sell item.

3. The device of claim 1, wherein the accounting unit is configured to: when an account item of any transaction recording data is updated, update the journalized data based on the transaction recording data having the updated account item.

4. The device of claim 1, wherein the transaction analyzer or the accounting unit prioritize the transaction recording data about the virtual assets over transaction recording data for general assets.

5. The device of claim 1, wherein the transaction analyzer is further configured to:
when the account item or the transaction classification item corresponding to the transaction detail recorded in the transaction recording data is absent in the transaction analysis table,
compare a transaction code included in the transaction recording data a transaction code included in another transaction recording data; and
determine the account item or the transaction classification item of the transaction recording data based on the comparison result.

6. A method for accounting for virtual assets, the method comprising:
receiving, by a receiver, log data including a plurality of transaction recording data from a virtual asset exchange server;
extracting, by a transaction analyzer, transaction recording data included in the log data, and allocating, by the transaction analyzer, an account item and a transaction classification item to the transaction recording data, with reference to a predetermined transaction analysis table; and
journalizing, by an accounting unit, the transaction recording data based on the account item and the transaction classification item to create journalized data,
wherein the allocating of the account item and the transaction classification item to the transaction recording data includes:
when the account item or the transaction classification item corresponding to transaction detail recorded in the transaction recording data is absent in the transaction analysis table,
setting the account item of the transaction recording data as an unknown variable transaction item; and
analyzing the transaction detail of the transaction recording data and setting the transaction classification item of the transaction recording data as a predetermined alternative transaction item based on the analysis result.

7. The method of claim 6, wherein the allocating of the account item and the transaction classification item to the transaction recording data includes:
upon determining, based on a result of analyzing the transaction detail of the transaction recording data, that a quantity of the virtual assets has increased, setting the transaction classification item of the transaction recording data as an alternative deposit item;
upon determining, based on the result of analyzing the transaction detail of the transaction recording data, that the quantity of the virtual assets has decreased, setting the transaction classification item of the transaction recording data as an alternative withdrawal item;
upon determining, based on the result of analyzing the transaction detail of the transaction recording data, that a cost for the virtual assets has been spent, setting the transaction classification item of the transaction recording data as an alternative buy item; and
upon determining, based on the result of analyzing the transaction detail of the transaction recording data, that a profit from the virtual assets has increased, setting the transaction classification item of the transaction recording data as an alternative sell item.

8. The method of claim 6, wherein the method further comprises, when an account item of any transaction recording data is updated, updating the journalized data based on the transaction recording data having the updated account item.

9. The method of claim 6, wherein the allocating of the account item and the transaction classification item to the transaction recording data or the journalizing of the transaction recording data includes prioritizing the transaction recording data about the virtual assets over transaction recording data for general assets.

10. The method of claim 6, wherein the allocating of the account item and the transaction classification item to the transaction recording data includes:
when the account item or the transaction classification item corresponding to the transaction detail recorded in the transaction recording data is absent in the transaction analysis table,
comparing a transaction code included in the transaction recording data a transaction code included in another transaction recording data; and
determining the account item or the transaction classification item of the transaction recording data based on the comparison result.
